(19) United States
(12) Patent Application Publication
(10) Pub. No.: US 2024/0416601 A1
(43) Pub. Date: Dec. 19, 2024

(54) METHOD OF PRODUCING A TIRE EQUIPPED WITH AN ELECTRONIC DEVICE

(71) Applicant: Bridgestone Europe NV/SA [BE/BE], Zaventem (BE)

(72) Inventors: Francesco Iozia, Roma (IT); Robin Frank Arends, Roma (IT)

(21) Appl. No.: 18/703,451

(22) PCT Filed: Oct. 27, 2022
(86) PCT No.: PCT/EP2022/080126

§ 371 Date: Apr. 22, 2024

(30) Foreign Application Priority Data
Oct. 29, 2021 (IT) 102021000027812

(51) Int. Cl. B29D 30/00

(52) U.S. Cl. CPC B29D 30/0061; B29D 2030/0083

(57) ABSTRACT

A production method for a tyre (8) provided with an electronic device (1) and having the steps of: inserting the electronic device (1) between a first strip (6) of rubber and a second strip (7) of rubber enclosing therebetween the electronic device (1) which itself defines a housing (5); applying the housing (5) to an innerliner (13) of a green tyre (8) such that the first strip (6) of rubber is in direct contact with the innerliner (13) and the second strip (7) of rubber is separated from the innerliner (13) by the interposition of the first strip (6) of rubber; and subjecting the green tyre (8) equipped with the housing (5) to a vulcanization process. The first rubber strip (6) is composed of completely green rubber while the second rubber strip (7) is composed of only partially vulcanized rubber, i.e., rubber that has started but not completed the vulcanization.

### TECHNICAL SECTOR

The present invention relates to a method of producing a tire equipped with an electronic device (in particular a transponder).

### BACKGROUND

In recent years, so-called “smart” tires have emerged, which are capable of forming an active part of modern vehicles, supplying information concerning the type of tires mounted, information concerning the status of the tires and also information concerning environmental conditions.

A “smart” tire is normally equipped with a transponder (that is, an electronic device suitable for communicating in radio frequency) which permits remote communication (that is, to both the vehicle whereupon the tire is mounted and to an operator who must carry out the checking or the replacement of the tire) of the identification, the characteristics and the history of the tire.

Recently, the unification has been proposed of RFID (“Radio-Frequency IDentification”) technology, based upon the presence of transponders, and TPMS (“Tire Pressure Monitoring Systems”) technology, which measures the effective inflation pressure in order to store within transponders the effective inflation pressure and then remotely communicate the effective inflation pressure by means of the transponders themselves.

A transponder intended to be coupled to a tire is inserted beforehand into a rubber housing that completely surrounds the transponder on all sides. Subsequently, in order to couple a transponder to a tire, it is possible to attach the transponder to an inner surface of the tire (typically above the innerliner that ensures the air tightness of the tire) or else it is possible to integrate the transponder inside the side wall of the tire (i.e., arrange the transponder in the middle of the various layers that make up the side wall of the tire). Attaching the transponder to an inner surface of the tire does not change the structure of the tire in any way concerning the presence of foreign bodies and therefore ensures that the tire may offer the expected performance. A transponder may be attached to the inner surface of the tire when the tire is still green (i.e., before vulcanizing the tire) or when the tire has already been vulcanized.

The tire is first wetted with a layer of lubricant that has the function of facilitating the detachment of the tire from the vulcanization mould at the end of the vulcanization process (alternatively the blister of the vulcanization mould could be wetted using the lubricant); consequently, the surface of the vulcanized tire has a layer of lubricant that must be removed locally (for example by cleaning using a laser beam) in the area where the transponder is applied (otherwise, the transponder would not be able to adhere with an adequate force to the surface of the tire). Consequently, attaching the transponder to the inner surface of the tire when the tire has already been vulcanized requires additional processing (cleaning the area where the transponder is applied) which increases production times and costs.

In addition, to ensure adequate adhesion of the transponder to the surface of the vulcanized tire, it is necessary to use an adhesive (glue) that is sufficiently strong and compatible with the rubber compound that makes up the tire innerliner, and that does not in any way damage the integrity of the tire innerliner; this adhesive also constitutes an additional cost in economic and environmental terms.

It would therefore be preferable, in order to reduce production times and costs, to attach the transponder to the inner surface of the tire when the tire is still green (i.e., before vulcanizing the tire). It has, however, been observed that the high pressure and high temperature reached during the vulcanization process may cause pieces of the transponder to emerge outside the rubber housing thereof (the so-called “surfacing” phenomenon), often causing a malfunction (if not the complete failure) of the transponder. In addition, the high pressure and high temperature reached during the vulcanization process may bring pieces of the transponder into contact with the carcass cords, thereby often causing a malfunction (if not complete failure) of the transponder and also negatively interfering with the operation of the carcass cords. Finally, the high pressure and high temperature that are reached during the vulcanization process may cause irregularities in the innerliner (particularly at the edge of the rubber housing of the transponder) that in the long run may cause cracks in the innerliner, leading to air leaks.

### SUMMARY

The purpose of the present invention is to provide a production method for a tire equipped with an electronic device that avoids damage to the tire or to the electronic device and that is at the same time easy and economical to implement.

### BRIEF DESCRIPTION OF THE DRAWINGS

The present invention will now be described with reference to the attached drawings, which illustrate an exemplary, non-limiting embodiment, wherein:

FIG. 1 is a schematic view of a transponder inserted into a rubber housing;

FIGS. 2 and 3 are two cross-sectional views of the transponder of FIG. 1 according to the section line II-II and according to the section line III-III, respectively;

FIG. 4 is a perspective view of the transponder in FIG. 1;

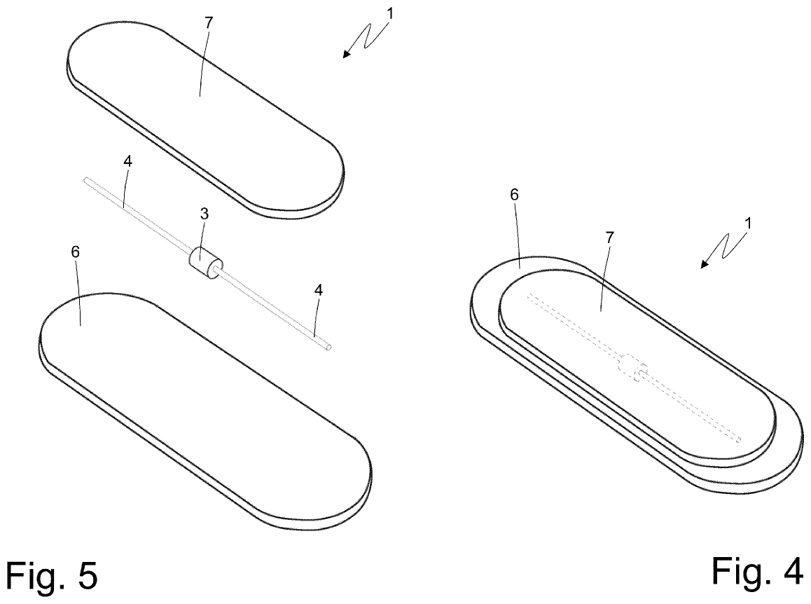

FIG. 5 is an exploded perspective view of the transponder in FIG. 1;

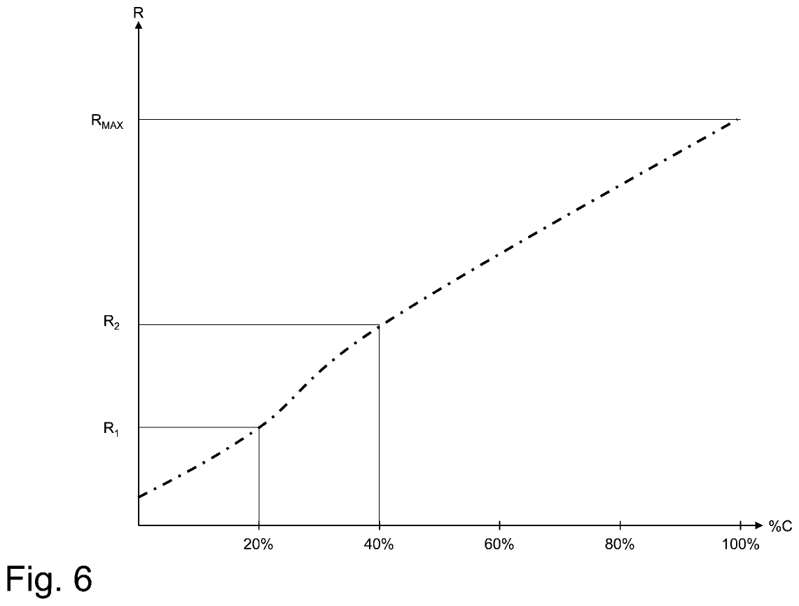

FIGS. 6 and 7 are two graphs showing the change in strength and adhesiveness of the rubber as the vulcanization process progresses; and

FIG. 8 is a schematic, cross-sectional view of a tire whereto the transponder in FIG. 1 has been applied.

### DETAILED DESCRIPTION

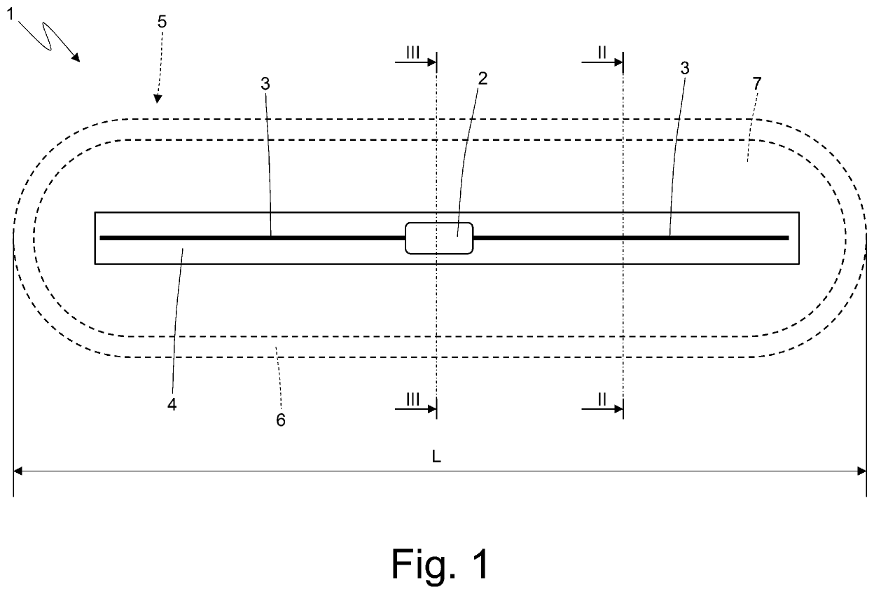

In FIG. 1, the numeral 1 denotes a transponder in the entirety thereof, i.e., an electronic device (normally passive, i.e., without a dedicated power supply) that is capable of storing information and that is capable of communicating by means of radio frequency. In other words, the transponder 1 is a “smart label” of small dimensions that is suitable for responding to remote polling on the part of specific fixed or portable devices, called readers (or polling devices); a reader is capable of reading and/or modifying the information contained within the transponder 1 that is being polled whilst communicating with the transponder 1 itself in radio frequency. Accordingly, the transponder 1 is part of a wireless reading and/or writing system that operates according to so-called RFID technology (“Radio-Frequency IDentification”).

According to that which is shown in FIG. 1, the transponder 1 comprises an electronic circuit 2 (i.e., a microchip) equipped with non-volatile memory (typically EEPROM or FRAM, the latter being more costly, but technologically more advanced), an antenna 3 connected to the electronic circuit 2, and a support 4 that carries both the electronic circuit 2 and the antenna 3 and that is frequently defined as a “substrate” (that may, for example, comprise a thin sheet of copper-coated vetronite, FR4, or other similar materials); as also detailed hereinafter, the support 4 could also not be present. In the embodiment shown in FIG. 1, the antenna 3 is a dipole antenna (or simply a dipole) and comprises two equally open arms that are implemented using a linear electrical conductor whereupon the currents flow that remotely radiate the electromagnetic field.

In use, the antenna 3 receives an electromagnetic signal that, by electromagnetic induction, induces a difference in electrical potential within the antenna 3, which generates the circulation of an electrical current within the electronic circuit 2 in order to supply power to the electronic circuit 2 itself; the electronic circuit 2, thus activated, transmits the data contained within the memory thereof by means of the antenna 3 and, where appropriate, also modifies the data contained within the memory thereof.

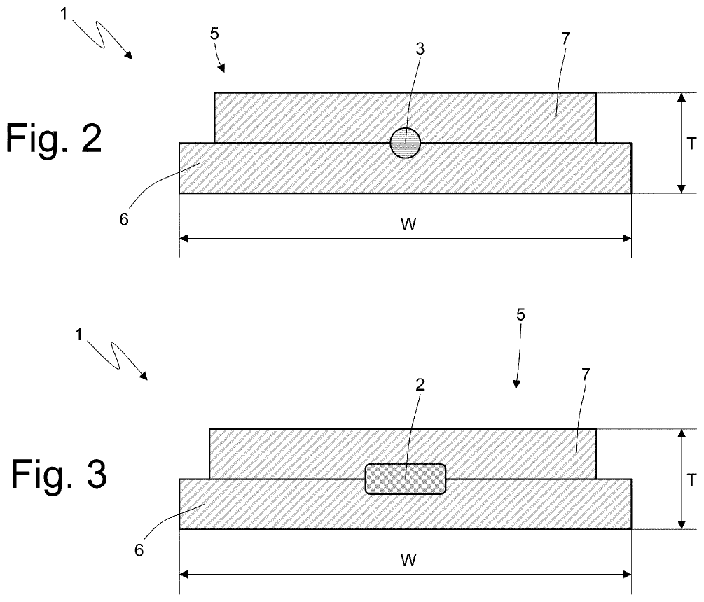

According to that which is shown in FIGS. 1, 2 and 3, the transponder 1 is inserted into a rubber housing 5, comprising two strips 6 and 7 of green rubber superimposed and pressed one against the other; in general, the two green rubber strips 6 and 7 of the housing 5 are longer/wider than the transponder 1 (i.e., than the electronic circuit 2 and the antenna 3).

According to a different embodiment (not shown) the support 4 is absent and the function thereof is performed by the strips 6 and 7 of rubber of the housing 5.

According to a preferred (but clearly non-limiting) embodiment, the thickness T of the housing 5 (containing the transponder 1 therein) before vulcanization is between 2.3 and 2.9 mm (and is for example equal to 2.6 mm), the width W of the housing 5 before vulcanization is approx. 20-45 mm (and is for example equal to 40 mm), and the length L of the housing 5 before vulcanization is approx. 70-90 mm (and is for example equal to 80 mm). According to a preferred embodiment, before vulcanization the thickness T of the housing 5 is equal to the thickness of the transponder 1 with an added thickness of 0.4-0.5 mm per side (i.e., overall 0.8-1.0 mm). In this way, the two rubber strips 6 and 7 before vulcanization have the same thickness (equal to 0.4-0.5 mm), which is chosen in such a way that between the transponder 1 and the outer surface of each rubber strip 6 or 7 before vulcanization there is a rubber thickness of not less than 0.5 mm (more generally not less than 0.4 mm); i.e., between the transponder 1 and the outer surface of each rubber strip 6 or 7 before vulcanization at least 0.5 mm (0.4 mm) of rubber must be provided. According to this rule, if the transponder 1 has a maximum thickness (i.e., in the thickest area) of 1.6 mm, then the thickness T of the housing 5 (containing the transponder 1 therein) before vulcanization is equal to 2.6 mm; if the transponder 1 is thicker or thinner, the thickness T of the housing 5 is similarly greater or lesser.

Consequently, the two rubber strips 6 and 7 before vulcanization have the same thickness, which is equal to half the thickness of the transponder 1 with the addition of about 0.4-0.5 mm.

When the two rubber strips 6 and 7 before vulcanization have the same thickness, which is equal to half the thickness of the transponder 1 with the addition of about 0.4-0.5 mm, between the transponder 1 (enclosed between the two rubber strips 6 and 7) and the outer surface of the two rubber strips 6 and 7 before vulcanization there is a layer of rubber having a thickness of about 0.4-0.5 mm. This non-vulcanized rubber thickness ensures that, at the end of the vulcanization process, between the transponder 1 (enclosed between the two rubber strips 6 and 7) and the outer surface of the two vulcanized rubber strips 6 and 7 there is a layer of vulcanized rubber having a thickness of at least 0.2 mm (i.e., not less than 0.2-0.3 mm and generally also slightly greater than 0.2-0.3 mm). In other words, the final result to be obtained at the end of the vulcanization process is that the transponder 1 (enclosed between the two rubber strips 6 and 7) is covered (and therefore “protected”) by at least 0.2-0.3 mm of vulcanized rubber.

Generally, the length L of the housing 5 before vulcanization is equal to the length of the transponder 1 with the addition of 2-5 mm per side (i.e., a total of 4-10 mm).

In the embodiment illustrated in the accompanying figures, the rubber strip 7 is slightly smaller (i.e., narrower and shorter) than the underlying rubber strip 6 (the difference in size between the two rubber strips 6 and 7 before vulcanization is between 0.5 mm and 8 mm); in this regard it is important to note that the rubber strip 7 which is slightly smaller (i.e., narrower and shorter) than the underlying rubber strip 6 allows a technical effect to be obtained: a rubber step on the innerliner of the tire creates a block against the flow of air during vulcanization, and during the vulcanization the rubber step is reduced (assuming a substantially conical shape) and various moulding defects may be avoided. According to a different embodiment (not shown), the rubber strip 7 has exactly the same size as the underlying rubber strip 6. In particular, in the embodiment shown in the accompanying figures, the rubber strip 6 has a length L before vulcanization of between 75 and 85 mm (preferably 80 mm), a width W before vulcanization of between 20 and 45 mm (preferably 40 mm), and a thickness T before vulcanization of between 1.2 and 1.4 mm (preferably 1.3 mm); instead, the rubber strip 7 has a length L before vulcanization of between 65 and 75 mm (preferably 70 mm), a width W before vulcanization of between 33 and 37 mm (preferably 35 mm), and a thickness T before vulcanization of between 1.2 and 1.4 mm (preferably 1.3 mm).

According to a preferred embodiment, in plan view, each rubber strip 6 or 7 has two smaller rounded ends so as to be free of sharp edges.

The rubber strip 6 is composed of completely green rubber (i.e., rubber that has never been vulcanized in any way, not even partially), while the rubber strip 7 is composed of only partially vulcanized rubber (i.e., rubber wherein the vulcanization has begun but has not been completed, i.e., rubber that is neither completely green nor completely vulcanized). In particular, the rubber strip 7 is composed of 20-40% vulcanized rubber, i.e., rubber that has been subjected to 20-40% of the vulcanization (as better described hereinafter).

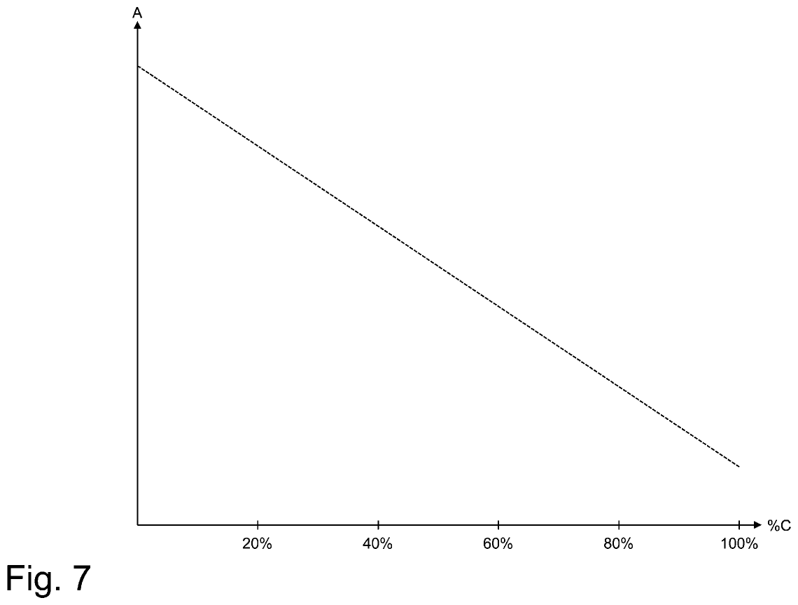

As shown in FIGS. 6 and 7, as the percentage % C of vulcanization progresses from 0% (corresponding to completely green rubber) to 100% (corresponding to completely vulcanized rubber), the ability of the rubber to form thioether bonds (i.e., the ability of the rubber to adhere to other materials) as shown in FIG. 7 decreases and at the same time the rigidity R of the rubber as shown in FIG. 6 increases. In the mechanics of materials, stiffness is the ability of a body to oppose (resist) the elastic deformation caused by an external force, and the inverse thereof is called yieldability or flexibility; the ratio between the external force and the elastic deformation is called “Young's modulus”, or the modulus of elasticity (wherein the unit of measurement thereof is N/m²), and represents a direct measurement of the rigidity of a material (the lower the Young's modulus, the lower the stiffness, and therefore the material deforms more easily).

Generally, the percentage % C of vulcanization is measured based upon the duration of time for which the rubber has been subjected to the vulcanization temperature (typically between 16° and 180° C. or more generally between 140 and 200° C.); thus a vulcanization percentage % C equal to 50% indicates that the rubber has been subjected to the vulcanization temperature for 50% of the time necessary in order to achieve complete vulcanization.

According to a preferred embodiment shown in FIG. 6, the rubber strip 7 is composed of rubber having a stiffness R of between 20% (R₁) and 40% (R₂) of a maximum stiffness R_{MAX} reached upon completion of the vulcanization (alternatively, the stiffness R could be between 20-25% and 50% of the maximum stiffness R_{MAX} reached upon completely of the vulcanization). As mentioned above, the stiffness R may be measured by means of the corresponding “Young's modulus” or the modulus of elasticity, and thus the increase in stiffness R corresponds to an increase in the “Young's modulus”. In particular, the rubber strip 7 is composed of rubber having a tangential elastic constant of between 50 Nm and 100 Nm (more generally of between 40 Nm and 120 Nm).

Preferably, the two rubber strips 6 and 7 are composed of exactly the same type of rubber compound; alternatively, the two rubber strips 6 and 7 could be composed of two different types of rubber compound.

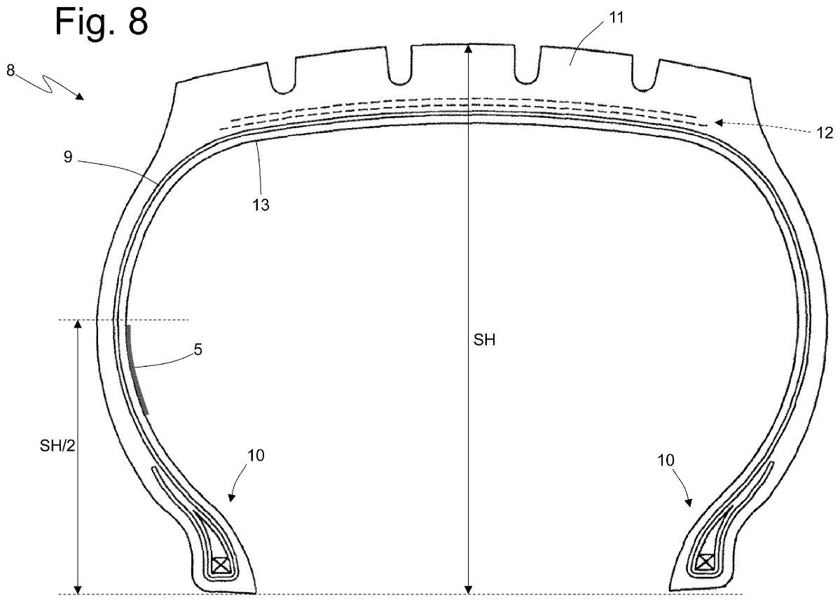

According to that shown in FIG. 8, the housing 5 containing the transponder 1 is coupled (attached) to a tire 8 comprising a toroidal casing 9 that is partially folded over on itself and therefore has two side flaps (i.e., two layers superimposed therebetween and commonly referred to as “turn-up”). Two annular beads 10 are provided at opposite sides of the carcass 9, wherein each thereof is surrounded by the carcass 9. The carcass 9 supports an annular tread 11 with the interposition of a tread belt 12. Arranged within the body ply 9 is an innerliner 13 which is airtight, constitutes an inner lining and has the function of retaining the air within the tire 8 in order to maintain the inflation pressure of the same tire 8 over time.

The construction of the tire 8 involves constructing the housing 5 by inserting the transponder 1 between the two rubber strips 6 and then applying (attaching) the housing 5 to the innerliner 13 of the green tire 8 in such a way that the rubber strip 6 is in direct contact with the innerliner 13 and the rubber strip 7 is separated from the innerliner 13 by the interposition of the rubber strip 6 (i.e., in such a way that the rubber strip 6 is on the side of the innerliner 13 and that the rubber strip 7 is on the opposite side of the innerliner 13).

Once the housing 5 (containing the transponder 1 inside) has been applied to the innerliner 13 of the green tire 8, the green tire 8, provided with the housing 5, is subjected to a vulcanization process at the end whereof the housing 5 (containing the transponder 1 therein) has become an integral and inseparable part of the tire 8. Obviously, the housing 5 may be applied to the innerliner 13 of the green tire 8 in any position and that shown in FIG. 8 is only one possible non-limiting example.

According to a preferred (but not binding) embodiment, shown in FIG. 8, the housing 5 is applied to the innerliner 1 of the green tire 8 at a side wall of the tire 8 and in such a way that a central portion of the housing 5 has a lower radial height, measured from a radially innermost portion and opposite a tread, of 50% of a height SH of the section of the tire (again measured radially). In this regard, it is important to note that the housing 5 is preferably applied to the innerliner 1 of the green tire 8 in such a way that the width W of the housing 5 is oriented radially, the length L of the housing 5 is oriented circumferentially, and the thickness T of the housing 5 is oriented axially.

The embodiments described herein may be combined without departing from the scope of protection of the present invention.

The production method described above has many advantages.

Firstly, the production method described above is particularly simple and economical insofar as it involves performing a few easily automated operations; in essence, compared to the production of a tire without a transponder 1, it is only a matter of adding the fastening of the housing 5 to a green tire 8 (an operation that may possibly be performed even before the so-called “tip-turning” when the green tire 8 is still flat).

Furthermore, the production method described above makes it possible to avoid the high pressure and high temperature reached during the vulcanization process that lead to pieces of the transponder 1 emerging outside the rubber housing 5 thereof (the so-called “surfacing” phenomenon), makes it possible to avoid the high pressure and high temperature reached during the vulcanization process that bring pieces of the transponder 1 into contact with the cords of the casing 9, and also makes it possible to prevent the high pressure and high temperature reached during the vulcanization process from causing irregularities in the innerliner 13.

Finally, the production method described above ensures adequately strong and resistant adhesion of the transponder 1 to the tire 8, thereby avoiding the risk that the transponder 1 may detach itself, even partially, from the tire 8.

It is important to emphasize that the fact that, in plan view, each strip 6 or 7 of rubber has two smaller rounded ends (in such a way as to be free of sharp edges) is important because the absence of sharp edges (which instead would be there if the shape, in plan view, were perfectly rectangular) reduces the stresses that the housing 5 transmits to the innerliner 13 during the vulcanization process.

1-13. (canceled)

14. A method of producing a tire equipped with an electronic device, the method comprising:
inserting the electronic device between a first rubber strip and a second rubber strip that enclose there between the electronic device which itself defines a housing;
applying the housing to an innerliner of a green tire, wherein the first strip of rubber is in direct contact with the innerliner and the second strip of rubber is separated from the innerliner by interposition of the first strip of rubber; and
subjecting the green tire equipped with the housing to a vulcanization process;
wherein the first rubber strip is composed of completely green rubber; and
wherein the second rubber strip is composed of partially vulcanized rubber.

15. The method of claim 14, wherein the second strip of rubber is composed of 20-40% vulcanized rubber.

16. The method of claim 14, wherein the second rubber strip is composed of rubber having a stiffness of between 25% and 50% of a maximum stiffness reached upon completion of the vulcanization.

17. The method of claim 14, wherein the second strip of rubber is composed of rubber having a tangential elastic constant of between 40 Nm and 120 Nm.

18. The method of claim 14, wherein the housing before vulcanization comprises an overall thickness equal to the thickness of the electronic device in addition to 0.5 mm per side.

19. The method of claim 14, wherein between the electronic device and the outer surface of each rubber strip before vulcanization there is a rubber thickness of not less than 0.4 mm.

20. The method of claim 19, wherein the rubber thickness between the electronic device and the outer surface of each rubber strip before vulcanization is not less than 0.5 mm.

21. The method of claim 14, wherein between the electronic device and the outer surface of each rubber strip after vulcanization there is a rubber thickness of not less than 0.2 mm.

22. The method of claim 21, wherein the rubber thickness between the electronic device and the outer surface of each rubber strip after vulcanization is not less than 0.3 mm.

23. The method of claim 14, wherein the second rubber strip is smaller than the first rubber strip.

24. The method of claim 23, wherein a difference in size between the two rubber strips is between 0.5 mm and 8 mm.

25. The method of claim 14, wherein, in plan view, each rubber strip has two smaller rounded ends and free of sharp edges.

26. The method of claim 14, wherein the two strips of rubber have a same thickness which is equal to half the thickness of the electronic device in addition to 0.5 mm.

27. The method of claim 14, wherein:
the first strip of rubber has a length of between 75 and 85 mm, a width of between 20 and 45 mm, and a thickness of between 1.2 and 1.4 mm; and
the second strip of rubber has a length of between 65 and 75 mm, a width of between 33 and 37 mm, and a thickness of between 1.2 and 1.4 mm.

28. The method of claim 14, wherein:
the housing is applied to the innerliner of a green tire at a side wall of the tire; and
a central portion of the housing has a radial height, measured from a radially innermost portion and opposite a tread, of less than 50% of a height of a respective section of the tire.
